(19) United States
(12) Patent Application Publication
(10) Pub. No.: US 2026/0205835 A1
(43) Pub. Date: Jul. 16, 2026

(54) METHOD OF PREPARING A USER EQUIPMENT FOR TESTS, METHOD OF TESTING A USER EQUIPMENT, AND SYSTEM FOR TESTING A USER EQUIPMENT

(71) Applicant: Rohde & Schwarz GmbH & Co. KG, Muenchen (DE)

(72) Inventor: Loknath GHOSH, Fleet (GB)

(21) Appl. No.: 19/016,309

(22) Filed: Jan. 10, 2025

(51) Int. Cl. H04W 24/06

(52) U.S. Cl. CPC H04W 24/06

(57) ABSTRACT

A test preparation method includes: sending an attention command (AT command) to the user equipment for prompting the user equipment to delete any existing user equipment route selection policies (URSPs) from the user equipment; receiving, by the user equipment, the AT command; and deleting, by the user equipment, all URSPs from the user equipment, thereby setting the user equipment for testing. In addition, a system for testing a user equipment is described. The system has the user equipment comprising a reception interface, a storage medium having URSPs stored, and an electronic circuit. The reception interface is configured to receive an AT command and to forward the AT command to the electronic circuit that is configured to delete all URSPs from the storage medium of the user equipment in reaction to receiving the AT command via the reception interface of the user equipment.

### FIELD OF THE DISCLOSURE

Embodiments of the present disclosure generally relate to a method of preparing a user equipment for tests. Embodiments of the present disclosure also relate to a method of testing a user equipment and to a system for testing a user equipment.

### BACKGROUND

In 5G cellular networks, user equipment, e.g. mobile devices like mobile phones or mobile terminals, can be provided with user equipment route selection policies (URSPs). The URSPs instruct the user equipment to route traffic data from a specific application through an associated protocol data unit (PDU) session. In case the associated PDU session does not exist yet, it is established first.

When performing tests of the user equipment, URSPs persisting on the user equipment can influence the test results. Generally, URSPs can be deleted from the user equipment using a non-access stratum (NAS) signaling message. However, this requires the user equipment to be connected to a test network at least, causing some efforts.

Accordingly, there is a need for a method of preparing a user equipment that ensures that no URSPs are present on the user equipment before testing and that does not rely on the user equipment being connected to a test network. Hence, the testing can be performed in a more efficient manner.

### SUMMARY

The following summary of the present disclosure is intended to introduce different concepts in a simplified form that are described in further detail in the detailed description provided below. This summary is neither intended to denote essential features of the present disclosure nor shall this summary be used as an aid in determining the scope of the claimed subject matter.

Embodiments of the present disclosure provide a method of preparing a user equipment for tests. In an embodiment, the method comprises sending an attention command (AT command) to the user equipment (UE) for prompting the user equipment to delete any existing user equipment route selection policies from the user equipment, receiving, by the user equipment, the AT command, and deleting, by the user equipment, all user equipment route selection policies from the user equipment, thereby setting the user equipment for testing.

Accordingly, methods of the present disclosure ensure that testing can be performed on the user equipment without any previous user equipment route selection policies (URSPs) influencing the test. In an embodiment, the user equipment receives the AT command and processes the AT command, thereby deleting all user equipment route selection policies stored on the user equipment, e.g. in a storage medium of the user equipment. Since the URSPs are deleted by processing the AT command received, it is not necessary to connect the user equipment to a test network previously, thereby reducing the efforts required for preparing the user equipment for appropriate testing.

In an embodiment, the AT command may be sent to the user equipment especially before testing of the user equipment is initiated. Hence, the whole testing procedure can be performed without being influenced by former URSPs. In other words, the user equipment is free of URSPs before the tests are performed, e.g. a certain test routine is started.

In an embodiment, the AT command may be sent to the user equipment before the user equipment is connected to a test network. Accordingly, test execution time can be reduced, since it is not necessary to wait until the user equipment is connected to the test network. This or other methods of the disclosure thus ensures efficient testing.

In an embodiment, connecting to the test network may be part of the tests performed, e.g. testing the behavior of the user equipment when connecting to the (test) network.

For instance, testing can be initiated faster than with an alternative approach of prompting deletion of URSPs via a corresponding non-access stratum (NAS) signaling message. For sending a NAS signaling message to the user equipment, the user equipment needs to be connected to the network and signaling needs to be established. These limitations do not apply to sending, receiving and processing AT commands.

For example, the AT command may be sent to the user equipment immediately after the user equipment is powered on. Hence, the method can ensure that the user equipment is ready for testing quickly after it is powered on. The AT command may be sent to the user equipment for example less than 15, less than 10, or less than 5 seconds after it has been powered on. The time span may be defined, e.g. set, in order to ensure that an operating system and/or a driver for a reception interface of the user equipment has been loaded appropriately.

In an embodiment, the AT command may be sent to the user equipment by a system simulator. Hence, preparation of the user equipment for tests and subsequent testing of the user equipment both can be performed by the system simulator, i.e. via a single apparatus. The preparation of the user equipment is thus implemented in a simple and efficient manner.

According to another aspect, configurations associated with the deleted user equipment route selection policies, for example, are also deleted from the user equipment. Testing of the user equipment can thus be performed without any influence from configurations associated with deleted user equipment route selection policies.

Embodiments of the present disclosure also provide a method of testing a user equipment, wherein the user equipment was prepared for tests by any one of (or all of) the methods of preparing a user equipment for tests as described above. Testing of the user equipment is initiated whilst no user equipment route selection policies, URSPs, are present on the user equipment. Accordingly, the testing is not influenced by any previous URSPs.

Embodiments of the present disclosure further provide a system for testing a user equipment. In an embodiment, the system includes the user equipment comprising a reception interface, a storage medium having user equipment route selection policies stored thereon, and an electronic circuit. The reception interface is configured to receive an AT command and to forward the AT command to the electronic circuit that is configured to delete all user equipment route selection policies from the storage medium of the user equipment in reaction to receiving the AT command via the reception interface of the user equipment. Hence, the user equipment can be tested without user equipment route selection policies influencing the test. The electronic circuit is configured to process the AT command received, wherein processing the AT command results in deleting all user equipment route selection policies from the storage medium of the user equipment.

In an embodiment, the electronic circuit may further be configured to delete configurations associated with the deleted user equipment route selection policies from the user equipment. Influence of these configurations on the tests of the user equipment can thus be ruled out.

According to one aspect, the system can comprise, for example, a device tester. The device tester may be configured to send the AT command to the user equipment for prompting the user equipment to delete user equipment route selection policies from the storage medium of the user equipment. The device tester is thus enabled to prepare the user equipment for tests.

In a certain embodiment, the device tester can be configured to send the AT command to the user equipment before testing of the user equipment is initiated. Hence, it is ensured that the complete testing procedure is free from influence by user equipment route selection policies.

In some embodiments, the device tester may be a system simulator configured to send the AT command to the user equipment before providing a test network for the user equipment. It is thus made sure that user equipment route selection policies are removed from the user equipment before the user equipment can connect to the test network of the system simulator.

In an embodiment, the AT command may be of type “set” or “execute”. In an embodiment, the user equipment is set by the AT command processed, as the AT command is used to modify/configure the user equipment, namely parameters/settings of the user equipment. In an alternative, the AT command processed results in execution of the deletion, as the AT command is used to perform an operation on the user equipment, e.g. deleting the user equipment route selection policies.

Generally, the AT command may relate to a single-line instruction. The AT command may be, for example, part of a set of AT commands that includes a series of short text strings that can be combined to produce an operation.

### DESCRIPTION OF THE DRAWINGS

The foregoing aspects and many of the attendant advantages of the claimed subject matter will become more readily appreciated as the same become better understood by reference to the following detailed description, when taken in conjunction with the accompanying drawings, wherein:

FIG. 1 is a block diagram schematically illustrating a system for testing a user equipment according to an embodiment of the present disclosure; and

FIG. 2 is a flowchart schematically illustrating a method of preparing a user equipment for tests according to an embodiment of the present disclosure.

### DETAILED DESCRIPTION

The detailed description set forth below in connection with the appended drawings, where like numerals reference like elements, is intended as a description of various embodiments of the disclosed subject matter and is not intended to represent the only embodiments. Each embodiment described in this disclosure is provided merely as an example or illustration and should not be construed as preferred or advantageous over other embodiments. The illustrative examples provided herein are not intended to be exhaustive or to limit the claimed subject matter to the precise forms disclosed.

User equipment is to be understood as a communication device for an end-user, e.g. a mobile terminal, a mobile phone or any computing device equipped with a mobile broadband modem.

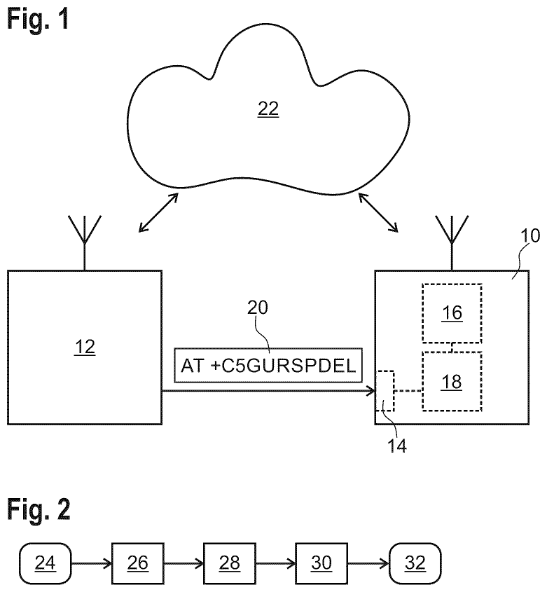

In FIG. 1, a system for testing a user equipment 10 is shown. In the shown embodiment, the system comprises a user equipment 10 and a device tester 12. As shown, the user equipment 10 comprises a reception interface 14, a storage medium 16 having user equipment route selection policies (URSPs) stored thereon, and an electronic circuit 18.

The reception interface 14 can be a wireless interface or a wired interface, for example, a universal serial bus (USB) interface. The reception interface 14 is configured to receive an AT command 20 and to forward the AT command 20 to the electronic circuit 18. The electronic circuit 18 is configured to process the AT command 20 received and to delete all URSPs from the storage medium 16 of the user equipment 10 in response to receiving and processing the AT command 20.

As a non-limiting example, the electronic circuit 18 can be configured to initiate the deletion when receiving the AT command 20 worded “AT +C5GURSPDEL”. Accordingly, the AT command 20 relates to a single-line instruction Typically, each AT command 20 starts with “AT” as indicated in the example.

In an embodiment, the device tester 12 is configured to send the AT command 20 to the user equipment 10 for prompting the user equipment 10 to delete URSPs from the storage medium 16 of the user equipment 10. In the shown embodiment, the device tester 12 is a system simulator configured to send the AT command 20 to the user equipment 10 before providing a test network 22 for the user equipment 10 to which the user equipment 10 may be connected afterwards for testing.

FIG. 2 is a flowchart that schematically illustrates an example of a method of preparing a user equipment 10 for tests.

The method starts at step 24. In step 26, an AT command 20 is sent to the user equipment 10 for prompting the user equipment 10 to delete any existing URSPs from the user equipment 10.

In an embodiment, the AT command 20 is sent to the user equipment 10 before testing of the user equipment 10 is initiated, e.g., prior to connecting the user equipment 10 to the test network 22 provided by the device tester 12. For example, the AT command 20 is sent to the user equipment 10 immediately after the user equipment 10 is powered on.

The user equipment 10 receives the AT command 20 in step 28 via the reception interface 14. The AT command 20 received via the reception interface 14 is forwarded to the electronic circuit 18 of the user equipment 10, which processes the AT command 20.

In step 30, the user equipment 10, based on the processed AT command 20, deletes all URSPs from the user equipment 10, for example all URSPs stored in the storage medium 16, thereby setting the user equipment 10 for testing. In other words, the electronic circuit 18 processing the AT command 20 deletes the URSPs from the storage medium 16.

In addition, any configurations associated with the deleted URSPs can also be deleted from the user equipment 10. The method terminates in a step 32, wherein the user equipment 10 is free of any previous URSPs and ready for being tested.

Consequently, the user equipment 10 was prepared for further testing by the method described above, as all previously stored URSPs have been deleted from the user equipment 10, for example the storage medium 16. Thus, the user equipment 10 may connect to the test network 22 provided by the device tester 12 for testing purposes in a prepared manner, which means without any previously stored URSP on the user equipment 10, as all URSPs have been deleted previously due to the method described above.

Certain embodiments disclosed herein include systems, apparatus, modules, units, devices, components, etc., that utilize circuitry (e.g., one or more circuits) in order to implement standards, protocols, methodologies or technologies disclosed herein, operably couple two or more components, generate information, process information, analyze information, generate signals, encode/decode signals, convert signals, transmit and/or receive signals, control other devices, etc. Circuitry of any type can be used. It will be appreciated that the term “information” can be used synonymously with the term “signals” in this paragraph. It will be further appreciated that the terms “circuitry,” “circuit,” “one or more circuits,” etc., can be used synonymously herein.

In an embodiment, circuitry includes, among other things, one or more computing devices such as a processor (e.g., a microprocessor), a central processing unit (CPU), a graphics processing unit (GPU), a digital signal processor (DSP), an application-specific integrated circuit (ASIC), a field programmable gate array (FPGA), a system on a chip (SoC), or the like, or any combinations thereof, and can include discrete digital or analog circuit elements or electronics, or combinations thereof. In an embodiment, circuitry includes hardware circuit implementations (e.g., implementations in analog circuitry, implementations in digital circuitry, and the like, and combinations thereof).

In an embodiment, circuitry includes combinations of circuits and computer program products having software or firmware instructions stored on one or more computer readable memories that work together to cause a device to perform one or more protocols, methodologies or technologies described herein. In an embodiment, circuitry includes circuits, such as, for example, microprocessors or portions of microprocessor, that require software, firmware, and the like for operation. In an embodiment, circuitry includes an implementation comprising one or more processors or portions thereof and accompanying software, firmware, hardware, and the like.

For example, the functionality described herein can be implemented by special purpose hardware-based computer systems or circuits, etc., or combinations of special purpose hardware and computer instructions. Each of these special purpose hardware-based computer systems or circuits, etc., or combinations of special purpose hardware circuits and computer instructions form specifically configured circuits, machines, apparatus, devices, etc., capable of implementing the functionality described herein.

Of course, in an embodiment, two or more of these components, or parts thereof, can be integrated or share hardware and/or software, circuitry, etc. In an embodiment, these components, or parts thereof, may be grouped in a single location or distributed over a wide area. In circumstances where the components are distributed, the components are accessible to each other via communication links.

In an embodiment, one or more of the components of the user equipment 10, the device tester 12, etc., referenced above include circuitry programmed to carry out one or more steps of any of the methods disclosed herein. In an embodiment, one or more computer-readable media associated with or accessible by such circuitry contains computer readable instructions embodied thereon that, when executed by such circuitry, cause the component or circuity to perform one or more steps of any of the methods disclosed herein.

In an embodiment, the computer readable instructions includes applications, programs, program modules, scripts, source code, program code, object code, byte code, compiled code, interpreted code, machine code, executable instructions, and/or the like (also referred to herein as executable instructions, instructions for execution, program code, computer program instructions, and/or similar terms used herein interchangeably).

In an embodiment, computer-readable media is any medium that stores computer readable instructions, or other information non-transitorily and is directly or indirectly accessible by a computing device, such as processor circuitry, etc., or other circuity disclosed herein etc. In other words, a computer-readable medium is a non-transitory memory at which one or more computing devices can access instructions, codes, data, or other information. As a non-limiting example, a computer-readable medium may include a volatile random access memory (RAM), a persistent data store such as a hard disk drive or a solid-state drive, or a combination thereof. In an embodiment, memory can be integrated with a processor, separate from a processor, or external to a computing system.

Accordingly, blocks of the block diagrams and/or flowchart illustrations support various combinations for performing the specified functions, combinations of operations for performing the specified functions and program instructions for performing the specified functions. These computer program instructions may be loaded onto one or more computer or computing devices, such as special purpose computer(s) or computing device(s) or other programmable data processing apparatus(es) to produce a specifically-configured machine, such that the instructions which execute on one or more computer or computing devices or other programmable data processing apparatus implement the functions specified in the flowchart block or blocks and/or carry out the methods described herein. Again, it should also be understood that each block of the block diagrams and flowchart illustrations, and combinations of blocks in the block diagrams and/or flowchart illustrations, or portions thereof, could be implemented by special purpose hardware-based computer systems or circuits, etc., that perform the specified functions or operations, or combinations of special purpose hardware and computer instructions.

It will be appreciated that in one or more embodiments, the term computer or computing device can include, for example, any computing device or processing structure, including but not limited to a processor (e.g., a microprocessor), a central processing unit (CPU), a digital signal processor (DSP), an application-specific integrated circuit (ASIC), a field-programmable gate array (FPGA), a system on a chip (SoC), a graphics processing unit (GPU) or the like, or any combinations thereof.

In the foregoing description, specific details are set forth to provide a thorough understanding of representative embodiments of the present disclosure. It will be apparent to one skilled in the art, however, that the embodiments disclosed herein may be practiced without embodying all of the specific details. In some instances, well-known process steps have not been described in detail in order not to unnecessarily obscure various aspects of the present disclosure.

Although the method and various embodiments thereof have been described as performing sequential steps, the claimed subject matter is not intended to be so limited. As nonlimiting examples, the described steps need not be performed in the described sequence and/or not all steps are required to perform the method. Moreover, embodiments are contemplated in which various steps are performed in parallel, in series, and/or a combination thereof. As such, one of ordinary skill will appreciate that such examples are within the scope of the claimed embodiments.

In the detailed description herein, references to “one embodiment”, “an embodiment”, “an example embodiment”, “one or more embodiments”, “some embodiments”, etc., indicate that the embodiment or embodiments described may include a particular feature, structure, or characteristic, but every embodiment may not necessarily include the particular feature, structure, or characteristic. Moreover, such phrases are not necessarily referring to the same embodiment or embodiments. In addition, when a particular feature, structure, or characteristic is described in connection with an embodiment or embodiments, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments. Thus, it will be appreciated that embodiments of the present disclosure may employ any combination of features described herein. All such combinations or sub-combinations of features are within the scope of the present disclosure.

Throughout this specification, terms of art may be used. These terms are to take on their ordinary meaning in the art from which they come, unless specifically defined herein or the context of their use would clearly suggest otherwise.

The drawings in the FIGURES are not to scale. Similar elements are generally denoted by similar references in the FIGURES. For the purposes of this disclosure, the same or similar elements may bear the same references. Furthermore, the presence of reference numbers or letters in the drawings cannot be considered limiting, even when such numbers or letters are indicated in the claims.

The present application may reference quantities and numbers. Unless specifically stated, such quantities and numbers are not to be considered restrictive, but exemplary of the possible quantities or numbers associated with the present application. Also in this regard, the present application may use the term “plurality” to reference a quantity or number. In this regard, the term “plurality” is meant to be any number that is more than one, for example, two, three, four, five, etc. The terms “about,” “approximately,” “near,” etc., mean plus or minus 5% of the stated value. For the purposes of the present disclosure, the phrase “at least one of A and B” is equivalent to “A and/or B” or vice versa, namely “A” alone, “B” alone or “A and B.”. Similarly, the phrase “at least one of A, B, and C,” for example, means (A), (B), (C), (A and B), (A and C), (B and C), or (A, B, and C), including all further possible permutations when greater than three elements are listed.

Where a range of values is provided, it is understood that each intervening value, to the tenth of the unit of the lower limit (unless the context clearly dictates otherwise), between the upper and lower limit of that range, and any other stated or intervening value in that stated range, is encompassed within the disclosure. The upper and lower limits of these smaller ranges may independently be included in the smaller ranges and are also encompassed within the disclosure, subject to any specifically excluded limit in the stated range. While the stated range includes one or both of the limits, ranges excluding either or both of those included limits are also included in the disclosure

The principles, representative embodiments, and modes of operation of the present disclosure have been described in the foregoing description. However, aspects of the present disclosure which are intended to be protected are not to be construed as limited to the particular embodiments disclosed. Further, the embodiments described herein are to be regarded as illustrative rather than restrictive. It will be appreciated that variations and changes may be made by others, and equivalents employed, without departing from the spirit of the present disclosure. Accordingly, it is expressly intended that all such variations, changes, and equivalents fall within the spirit and scope of the present disclosure, as claimed.

The embodiments of the invention in which an exclusive property or privilege is claimed are defined as follows:

1. A method of preparing a user equipment for tests, the method comprising:
sending an attention command (AT command) to the user equipment for prompting the user equipment to delete any existing user equipment route selection policies from the user equipment;
receiving, by the user equipment, the AT command; and
deleting, by the user equipment, all user equipment route selection policies from the user equipment, thereby setting the user equipment for testing.

2. The method according to claim 1, wherein the AT command is sent to the user equipment before testing of the user equipment is initiated.

3. The method according to claim 1, wherein the AT command is sent to the user equipment before the user equipment is connected to a test network.

4. The method according to claim 1, wherein the AT command is sent to the user equipment immediately after the user equipment is powered on.

5. The method according to claim 1, wherein the AT command is sent to the user equipment by a system simulator.

6. The method according to claim 1, wherein configurations associated with the deleted user equipment route selection policies are also deleted from the user equipment.

7. A method of testing a user equipment, wherein the user equipment was prepared for tests by the method according to claim 1 such that testing of the user equipment is initiated whilst no user equipment route selection policies are present on the user equipment.

8. A system for testing a user equipment, the system comprising user equipment including a reception interface, a storage medium having user equipment route selection policies stored thereon, and an electronic circuit, wherein the reception interface is configured to receive an AT command and to forward the AT command to the electronic circuit that is configured to delete all user equipment route selection policies from the storage medium of the user equipment in reaction to receiving the AT command via the reception interface of the user equipment.

9. The system according to claim 8, wherein the electronic circuit is further configured to delete configurations associated with the deleted user equipment route selection policies from the user equipment.

10. The system according to claim 8, further comprising a device tester, wherein the device tester is configured to send the AT command to the user equipment for prompting the user equipment to delete user equipment route selection policies from the storage medium of the user equipment.

11. The system according to claim 10, wherein the device tester is configured to send the AT command to the user equipment before testing of the user equipment is initiated.

12. The system according to claim 10, wherein the device tester is a system simulator configured to send the AT command to the user equipment before providing a test network for the user equipment.
